(19) United States
(12) Patent Application Publication
(10) Pub. No.: US 2022/0175147 A1
(43) Pub. Date: Jun. 9, 2022

(54) Surface Leveling Apparatus

(71) Applicant: DOUGLAS E MCKINLEY, JR., RICHLAND, WA (US)

(72) Inventor: DOUGLAS E MCKINLEY, JR., RICHLAND, WA (US)

(21) Appl. No.: 17/117,095

(22) Filed: Dec. 9, 2020

(51) Int. Cl. A47C 19/04; G01C 5/00; G01C 9/06; A47C 17/80

(52) U.S. Cl. CPC A47C 19/045; A47C 17/80; G01C 9/06; G01C 5/00

(57) ABSTRACT

A method and apparatus to adjust the angle of a surface is disclosed. The apparatus includes a measuring device having hardware components capable of generating a measurement of the position of the measuring device relative to the earth's gravity and circuitry capable of communicating the measurement to a controller and at least one electro-mechanical device capable of displacing the surface connected to the controller. The surface may be a bed and the present invention is particularly useful when the surface is a bed in a camper van. When the camper van is parked on a hill, the present invention provides a convenient method for making the bed inside the camper van level, or at an angle preferred by the user, for comfortable sleeping.

### TECHNICAL FIELD

The present invention relates to methods and apparatus to adjust a surface to a pre-determined angle. Among other uses, and not meant to be limiting, the present invention may provide a method and apparatus to automatically adjust a bed in a camper van to a pre-determined angle for improved sleeping comfort.

### SUMMARY OF THE INVENTION

The present invention may provide a method and apparatus to adjust the angle of a surface. Not meant to be limiting, the surface may be a bed and the present invention may be used when the surface is a bed in a camper van. When the present invention is utilized in conjunction with a bed in a camper van, it allows a user a quick and easy way to adjust the bed to an orientation preferred by the user regardless of the orientation of the camper van. So, for example and not meant to be limiting, when the camper van is parked on at an angle on a hill, the present invention provides a convenient method for adjusting the bed inside the camper van so that it is level, or at an angle preferred by the user, for comfortable sleeping or other uses.

The present invention may include a surface, a measuring device having hardware components capable of generating a measurement of the position of the measuring device relative to the earth's gravity, and circuitry capable of communicating the measurement to a controller which may control at least one electro-mechanical device capable of displacing the surface.

The present invention may thereby be operated by placing the measuring device upon the surface. The position of the surface may then be inferred from the position of the measuring device. The measuring device may be configured to communicate the position of the measuring device to the controller. The controller may be configured to activate at least one electro-mechanical device to displace the surface to a pre-determined position. The pre-determined position may be level, or at some other angle desired by the user.

Preferably, but not meant to be limiting, the measuring device may be a cell phone.

Preferably, but not meant to be limiting, the electro-mechanical device is selected from the group of a linear actuator, a hydraulic cylinder, a pump and bladder, a motorized pulley, and combinations thereof.

Preferably, but not meant to be limiting, the hardware components are a gyroscope, a accelerometer, and combinations thereof

Preferably, but not meant to be limiting, the controller is a single board microcontroller.

Preferably, but not meant to be limiting, the circuitry capable of communicating the measurement to a controller utilizes either a wired connection or a wireless protocol.

Preferably, but not meant to be limiting, the wireless protocol is selected from bluetooth, Wi-Fi, 4G, 5G and combinations thereof.

### BRIEF DESCRIPTION OF THE DRAWINGS

The following detailed description of an exemplary embodiment of the invention will be more readily understood when taken in conjunction with the following drawing, wherein:

FIG. 1 is an illustration of an exemplary embodiment the apparatus of the present invention.

### DETAILED DESCRIPTION OF THE PREFERRED EMBODIMENTS

For the purposes of promoting an understanding of the principles of the invention, reference will now be made to the embodiment illustrated in the drawing and specific language will be used to describe the same. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates.

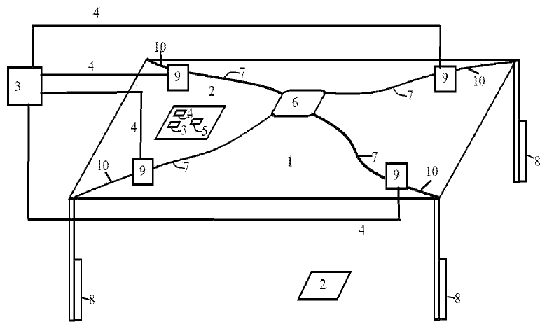

The exemplary embodiment of the present invention shown in FIG. 1 includes a surface 1, a measuring device 2 having hardware components 3 and 4 capable of generating a measurement of the position of the measuring device relative to the earth's gravity and circuitry 5 capable of communicating the measurement to a controller 6. The exemplary embodiment of the present invention shown in FIG. 1 shows the circuitry 5 capable of communicating the measurement to a controller 6 is shown as utilizing a wireless protocol. As will be apparent to those having ordinary skill in the are of communicating electronic signals, the circuitry 5 capable of communicating the measurement to a controller 6 could also be a wire.

As shown in FIG. 1, controller 6 of the exemplary embodiment of the present invention is connected with wires 7 to four switches 9. Power from power supply 3 is provided to switches 9 by wires 4 and power is then provided from switches 9 to electromechanical devices 8 by wires 10. Controller 6 of the exemplary embodiment of the present invention may turn switches 9 off and on as necessary to provide power from switches 9 to electromechanical devices 8 by wires 10, thereby causing them to displace bed 1 in a manner desired by the user.

While FIG. 1 shows the connections between Controller 6 and the four electro-mechanical devices 8 as wires 7, those of ordinary skill in the art will recognize that these connections could also be wireless.

When the measuring device 2 is placed upon the surface 1 the position of the surface 1 may be inferred from the position of the measuring device 2, and the measuring device 2 is configured to communicate the position of the measuring device to the controller 6 and the controller 6 is configured to be capable of activating switches 9 which in turn activate the electro-mechanical devices 8 to displace the surface 1 to a pre-determined position, as desired by the user. By way of example, and not meant to be limiting, in a configuration where the surface 1 is a bed in a camper van, the pre-determined position could be optimized to the user's sleeping preference, for example to adjust the bed as level, or at an incline, as desired by the user.

In the exemplary embodiment of FIG. 1, the measuring device 2 may be a cell phone and the surface 1 may be a bed. By placing the cell phone on the bed, the cell phone may then communicate the cell phone's position relative to gravity to the controller 6. Controller 6 may then turn switches 9 on and off to to cause the electro-mechanical devices 8 to displace the bed until the cell phone communicates to the controller 6 that the cell phone is in an orientation desired by the user, for example, as level. In this manner, if the cell phone is parallel to the bed, the bed will also be level.

Alternatively, the user may desire the bed to be at a predetermined angle, for example, and not meant to be limiting, a user may desire that the bed be at a 10 degree incline in the x plane, and level in the y plane. Controller 6 may then turn switches 9 on and off to to cause the electro-mechanical devices 8 to displace the bed until the cell phone communicates to the controller 6 that the cell phone is at a 10 degree incline in the x plane, and level in the y plane. In this manner, if the cell phone is parallel to the bed, the bed will also be at a 10 degree incline in the x plane, and level in the y plane.

The electro-mechanical devices 8 are shown in FIG. 1 as a linear actuator, however, as will be recognized by those of ordinary skill in the art the linear actuators shown in the figure could be replaced by any electro-mechanical device 8 capable of displacing the surface 1 in response to a signal from the controller 6, including, without limitation, a hydraulic cylinder, a pump and bladder, a motorized pulley, and combinations thereof. Additionally, while the exemplary embodiment of FIG. 1 shows the electro-mechanical devices 8 as located under the bed, where they would pushing the bed upwards, the electro-mechanical devices 8 could also be located above the bed, where they would pull the bed upwards. By way of example, and not meant to be limiting, in a configuration where the electro-mechanical devices 8 were located above the bed, and configured to pull the bed upwards, they could be attached to the ceiling of a structure, such as a camper van.

The hardware components 3 and 4 of measuring device 2 are shown in FIG. 1 are shown as a gyroscope 3 and a accelerometer 4. As will be apparent to those having ordinary skill in the art, these components can be replaced by any hardware components that have the capability to measure the orientation of the measuring device 2 in space. The controller 6 is shown in FIG. 1 as a single board microcontroller. The circuitry 5 capable of communicating the measurement to the controller 6 is shown in FIG. 1 as utilizing a wireless protocol. The wireless protocol may be selected as any suitable protocol, including without limitation, bluetooth, Wi-Fi, 4G, 5G and combinations thereof. Alternatively, as already mentioned, the circuitry 5 may be replaced with a wire connecting measuring device 2 with controller 6.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

Thus, the specifics of this example shown in the description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one” are used there is no intention to limit the claims to only one item unless specifically stated to the contrary in the claims. While the present invention finds utility for use with a cell phone to quickly adjust the angle of a bed in a camper van, the present invention is broadly applicable to any applications whereby it would be useful to quickly and easily adjust the angle of a surface using a measuring device and a controller.

1) An apparatus for adjusting the angle of a surface comprising:
a measuring device having hardware components capable of generating a measurement of the position of the measuring device relative to the earth's gravity and circuitry capable of communicating the measurement to a controller,
a controller, and
at least one electro-mechanical device capable of displacing a surface connected to the controller.

2) The apparatus of claim 1 wherein the measuring device is a cell phone.

3) The apparatus of claim 1 wherein the electro-mechanical device is selected from the group of a linear actuator, a hydraulic cylinder, a pump and bladder, a motorized pulley, and combinations thereof.

4) The apparatus of claim 1 wherein the hardware components are and gyroscope, a accelerometer, and combinations thereof.

5) The apparatus of claim 1 wherein the controller is a single board microcontroller.

6) The apparatus of claim 1 wherein the circuitry capable of communicating the measurement to a controller utilizes a wireless protocol.

7) The apparatus of claim 6 wherein the wireless protocol is selected from bluetooth, Wi-Fi, 4G, 5G and combinations thereof.

8) An apparatus for adjusting the angle of a surface comprising:
a surface,
a measuring device having hardware components capable of generating a measurement of the position of the measuring device relative to the earth's gravity and circuitry capable of communicating the measurement to a controller,
a controller, and
at least one electro-mechanical device capable of displacing the surface connected to the controller.

9) The apparatus of claim 8 wherein the measuring device is a cell phone.

10) The apparatus of claim 8 wherein the surface is a bed.

11) The apparatus of claim 8 wherein the electro-mechanical device is selected from the group of a linear actuator, a hydraulic cylinder, a pump and bladder, a motorized pulley and combinations thereof.

12) The apparatus of claim 8 wherein the hardware components are and gyroscope, a accelerometer, and combinations thereof.

13) The apparatus of claim 8 wherein the controller is a single board microcontroller.

14) The apparatus of claim 8 wherein the circuitry capable of communicating the measurement to a controller utilizes a wireless protocol.

15) The apparatus of claim 12 wherein the wireless protocol is selected from bluetooth, Wi-Fi, 4G, 5G and combinations thereof.

16) An apparatus for adjusting the angle of a surface comprising:
a surface,
a measuring device having hardware components capable of generating a measurement of the position of the measuring device relative to the earth's gravity and circuitry capable of communicating the measurement to a controller,
a controller, and
at least one electro-mechanical device capable of displacing the surface connected to the controller wherein when the measuring device is placed upon the surface the position of the surface may be inferred from the position of the measuring device, and the measuring device is configured to communicate the position of the measuring device to the controller and the controller is configured to be capable of activating at least one electro-mechanical device to displace the surface to a pre-determined position.

17) The apparatus of claim 16 wherein the measuring device is a cell phone.

18) The apparatus of claim 16 wherein the surface is a bed.

19) The apparatus of claim 16 wherein the electro-mechanical device is selected from the group of a linear actuator, a hydraulic cylinder, a pump and bladder, a motorized pulley and combinations thereof.

20) The apparatus of claim 16 wherein the hardware components are and gyroscope, a accelerometer, and combinations thereof.

21-23. (canceled)
